(19) United States
(12) Patent Application Publication
(10) Pub. No.: US 2010/0321139 A1
(43) Pub. Date: Dec. 23, 2010

(54) PERMANENT MAGNET AND METHOD OF PRODUCING PERMANENT MAGNET

(76) Inventors: Tetsuya Shoji, Susono-shi (JP); Hidefumi Kishimoto, Susono-shi (JP); Noritsugu Sakuma, Susono-shi (JP); Kenji Nakamura, Toyota-shi (JP); Tomonari Kogure, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/816,549

(22) Filed: Jun. 16, 2010

(30) Foreign Application Priority Data
Jun. 17, 2009 (JP) 2009-144479

(51) Int. Cl. H01F 7/02; B23K 31/02

(52) U.S. Cl. 335/302; 228/155

(57) ABSTRACT

A method of producing a permanent magnet includes: forming a multiplicity of solidified ribbons that are composed of nanosized crystal grains by melting a magnet material and rapidly cooling the molten product; binding the multiplicity of solidified ribbons together by compression molding and sintering to form a sintered body; and performing plastic forming on the sintered body to provide the sintered body with a distribution of strain which increases from a peripheral portion to a central portion.

### INCORPORATION BY REFERENCE

The disclosure of Japanese Patent Application No. 2009-144479 filed on Jun. 17, 2009 including the specification, drawings and abstract is incorporated herein by reference in its entirety.

### BACKGROUND OF THE INVENTION

1. Field of the Invention

The present invention relates to a permanent magnet that has a single composition and has distributions of coercivity and magnetization which vary from the central portion to the peripheral portion thereof, and a method of producing the permanent magnet.

2. Description of the Related Art

In recent years, development of electric vehicles and hybrid vehicles is in progress to overcome the environmental problems caused by exhaust emissions, and to overcome the problem that petroleum is a finite resource. Permanent magnets for use in rotors of driving motors of electric vehicles and hybrid vehicles are required to have specific features to improve the efficiency of the motors. For example, in the case of an interior magnet motor in which magnets are installed in the rotor, high coercivity is required in the peripheral portions of the magnets to maintain the magnetic forces of the magnets due to the external magnetic field being relatively stronger in the peripheral portions of the magnets than in the central portions thereof. On the contrary, in the central portions of the magnets, the coercivity does not have to be as strong as in the peripheral portions because the external magnetic field is relatively weaker in the central portions of the magnets than in the peripheral portions but high magnetization that contributes to the torque performance of the motor is required. In other words, high magnetization is required in the central portions of the magnets and high coercivity is required in the peripheral portions of the magnets.

Japanese Patent Application Publication No. 2005-11973 (JP-A-2005-11973) discloses achieving distributions of coercivity and magnetization which vary from the central portion to the peripheral portion in accordance with the distribution of Dy (dysprosium) concentration caused by diffusing Dy from a surface of a magnet. However, the use of Dy, which is an expensive rare-earth element, increases the cost and hinders the practical use of this method.

Japanese Patent Application Publication No. 2008-130781 (JP-A-2008-130781) and Japanese Patent Application Publication No. 2006-261433 (JP-A-2006-261433) disclose a magnet that has a composite structure in which a magnet with high magnetization is disposed at an inner side and a magnet with high coercivity is disposed at an outer side. However, there is a drawback that a plurality of different magnetic properties need to be put together which causes a laborious procedure and increases the cost.

As a method for variously changing the magnetic properties, Japanese Examined Patent Publication No. 7-33521 (JP-A-7-33521) describes a phenomenon in which the coercivity is decreased by crystallographic strain. Japanese Patent Application Publication No. 11-233323 (JP-A-11-233323) and Japanese Patent Application Publication No. 2003-342618 (JP-A-2003-342618) disclose using powder, as a raw material of a bonded magnet, which is obtained by filling a metal tube with a rare-earth-iron-boron-based magnet alloy powder that is obtained from rapidly quenched ribbons with a crystal grain size of 0.1 nm to 1 μm, applying uniaxial compression to the powder with upper and lower punches in a non-oxidative atmosphere at 650 to 900° C. to impart plastic deformation and magnetic anisotropy thereto, and pulverizing the resulting mass. Japanese Patent Application Publication No. 2007-250577 (JP-A-2007-250577) discloses a curved surface and surfaces that have protrusions, recessions and grooves in addition to a flat surface as examples of the pressurizing surface of a magnet shaping jig to be in contact with a magnetic material powder.

In JP-B-7-33521, JP-A-11-233323, JP-A-2003-342618 and JP-A-2007-250577, there is no suggestion about a permanent magnet and a method of producing the permanent magnet, which has a single composition and has distributions of coercivity and magnetization which vary from the central portion to the peripheral portion thereof.

### SUMMARY OF THE INVENTION

The present invention provides a permanent magnet that has a single composition and has distributions of coercivity and magnetization which vary from the central portion to the peripheral portion thereof, and a method of producing the permanent magnet.

A first aspect of the present invention relates to a method of producing a permanent magnet. The method includes: forming a multiplicity of solidified ribbons that are composed of nanosized crystal grains by melting a magnet material and rapidly cooling the resulting melt; binding the multiplicity of solidified ribbons together by compression molding and sintering to form a sintered body; and performing plastic working on the sintered body that provides the sintered body with a distribution of strain which increases from the peripheral portion to the central portion of the volume thereof.

According to the above aspect, a distribution of degree of orientation which is high in the peripheral portion and low in the central portion is created by plastic working that can create a distribution of strain which is low in the peripheral portion and high in the central portion.

A second aspect of the present invention relates to a permanent magnet. The permanent magnet includes a central portion, and a peripheral portion that is formed around the central portion. The central and the peripheral portions are formed of multiplicity of nanosized crystal grains that have been bound together by sintering. The central and peripheral portions have a uniform chemical composition across the entire portions of the central and peripheral portions. The central and peripheral portions have a distribution of degree of orientation which increases from the peripheral portion to the central portion.

According to the above aspect, a permanent magnet that has a peripheral portion with low degree of orientation and high coercivity and a central portion with high degree of orientation and high magnetization can be provided by taking advantage of the fact that the coercivity decreases and magnetization increases with increase in the degree of orientation.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a graph that shows a relation among the coercivity, degree of processing and manufacturing temperature;

FIG. 2A to 2D show residual magnetization, the coercivity and degree of orientation at each location in a cross-section perpendicular to a compressional axis for different degrees of processing; and

FIG. 3 is a graph that shows a relation among the degree of processing, the degree of orientation and rate of change of the coercivity.

### DETAILED DESCRIPTION OF AN EMBODIMENT

The permanent magnet of this embodiment requires neither a Dy (dysprosium) concentration distribution as described in JP-A-2005-11973 nor a combination of a plurality of magnets as described in JP-A-2008-130781 and JP-A-2006-261433, but has a substantially uniform chemical composition across the entire volume. The expression “having a substantially uniform chemical composition” means that the chemical composition is uniform within the variance of the production process.

The permanent magnet of this embodiment has a distribution of degree of orientation which increases from the peripheral portion to the central portion of the volume thereof. The degree of orientation is a degree that the individual crystal grains that form the permanent magnet are oriented in a specific direction. The degree of orientation in a specific portion such as peripheral portion or central portion refers to the average of the degrees of orientation of the crystal grains in the area, and is defined by the ratio Mr/Ms between the residual magnetization Mr and the saturation magnetization Ms in this embodiment.

Because the permanent magnet has a distribution of degree of orientation which increases from the peripheral portion to the central portion of the volume thereof, it has a distribution of coercivity which decreases from the peripheral portion to the central portion of the volume thereof and a distribution of magnetization which increases from the peripheral portion to the central portion of the volume thereof. More specifically, the degree of orientation, which is defined as the percentage of the ratio between the residual magnetization Mr and the saturation magnetization Ms “100×Mr/Ms”, may be 75% or higher at lowest in the peripheral portion.

The permanent magnet of this embodiment may be used for a motor in particular.

A method of producing a permanent magnet of this embodiment includes forming a multiplicity of solidified ribbons that are composed of nanosized crystal grains by melting a magnet material and rapidly cooling the molten product, binding the solidified ribbons together by compression molding and sintering to form a sintered body, and performing plastic forming on the sintered body that provides the sintered body with a distribution of strain in which increases from the peripheral portion to the central portion of the volume thereof.

While the method of the plastic working is not specifically limited, the strain distribution as described above in a plane perpendicular to the compressional axis can be easily achieved by uniaxial compression.

To distribute strain as described above, the uniaxial compression may be carried out in such a way that the surface of the sintered body to be compressed is not substantially constrained from being deformed in a direction perpendicular to the compressional axis by the compressing jig.

To distribute strain as described above, the uniaxial compression may be carried out in such a way that the degree of processing, which is defined as [(T0−T)/T0]×100 where T0 represents the height of workpiece before compression and T represents the height of workpiece after compression, is within the range of 40% to 70%.

In this embodiment, the use of nanosized crystal grains provides the following advantages.

(a) When the magnet is used in a motor, permanent magnets are required to have high coercivity at high temperature (at approximately 160° C. for automobiles). In general, an expensive rare-earth element such as Dy is added to ensure coercivity at high temperature. In this embodiment, however, the use of nanosized crystal grains is effective to reduce the temperature sensitivity of coercivity, that is, to reduce the decrease in coercivity with increase in temperature. As a result, high coercivity can be achieved even at high temperature.

(b) The sintered body for the permanent magnet of this embodiment needs to have sufficient workability to undergo plastic forming. Ordinary sintered magnets have a grain size of approximately 3 μm to 5 μm, and therefore have low workability and are likely to develop cracks, cannot undergo plastic forming to achieve high strain that is necessary to obtain a desired distribution of degree of orientation. In this embodiment, the use of nanosized crystal grains, in other words, crystal grains with a grain size of 30 nm to 500 nm, or may be 30 nm to 100 nm, allows plastic working that imparts high strain to be carried out. In general, magnet materials are hard and less likely to undergo plastic deformation. However, the plastic deformation during the plastic forming in this embodiment proceeds not only by slip deformation in the primary slip systems in the crystal grains of the sintered body but also by grain boundary sliding along boundaries between crystal grains. In such plastic deformation, because the nanosized fine crystal grains flow by their own slip deformation and the grain boundary sliding, the entire volume of the sintered body undergoes plastic deformation. When the crystal grains are nanosized, the number of crystal grain boundaries per unit volume is so large as compared with the case of ordinary micro-sized crystal grains that the number of sites for grain boundary sliding is large and the sintered body easily undergoes plastic deformation as a bulk body.

Hereinafter, an example of the present invention will be described in more detail. Permanent magnets of this example were produced under the following conditions and according to the procedure that is described below.

[Preparation of nanostructure] In an inert atmosphere such as N₂, a compound that has a chemical composition of Nd₁₅Fe₇₇B₇Ga₁ was melted using an arc smelting furnace, and the molten product was poured onto the circumferential surface of a cooling disk from a molten temperature of 1,450° C. to cool and solidify it rapidly, whereby a powder sample was obtained. The powder particles were ribbon-shaped which have grain size of 30 nm to 500 nm and composed of a mixture of crystalline and amorphous phases.

[Compression molding+sintering] The powder sample was sintered by rapidly heating from 500 to 700° C. at a rate of 20° C./sec in an inert atmosphere such as N₂ and was simultaneously subjected to compression molding at a 100 MPa or higher, and the resulting sintered bodies were rapidly cooled at an initial cooling rate of 10 to 50° C./sec. The whole process was completed within a period as short as one minute. The pressure sintering within a short period of time by rapid heating and cooling was to prevent grain coarsening. As a result, permanent magnets with diameter 10×8 to 9 mm were obtained.

[Plastic forming] The permanent magnets were subjected to plastic forming by means of uniaxial compression in the inert atmosphere. The forming conditions were as follows: temperature was at around 600° C. to 700° C.; degree of processing was 0 to 76%; SPS current (heating current) was 1000 A; heating rate was 2° C./sec to 50° C./sec; and compression pressure was 100 MPa. The plastic forming was carried out based on the net-shape principle so that strain might not be eventually released by cutting work or the like.

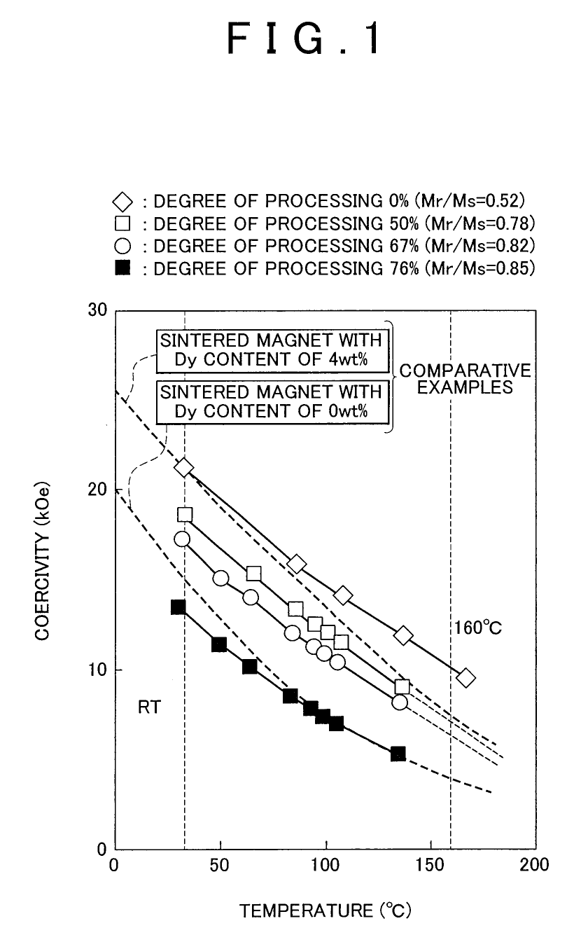

FIG. 1 shows a relation among the coercivity, the degree of processing and manufacturing temperature of the obtained permanent magnets of this example. The coercivity is measured at a central portion of each permanent magnet. The degree of processing is defined as [(T0−T)/T0]×100, where T0 represents the height of the permanent magnet before compression and T represents the height of the permanent magnet after the compression. The dotted lines in FIG. 1 show the measurements on Dy-added sintered magnets without plastic forming as comparative examples.

As shown in FIG. 1, the coercivity at the center after plastic forming decreases with increase in degree of processing and also decreases with increase in manufacturing temperature. A specific feature here is that the permanent magnets that have been subjected to the plastic forming of this example have a lower tendency to decrease in coercivity with increase in temperature than the Dy-added sintered magnets as comparative examples. In other words, the permanent magnet of this example can maintain a higher coercivity at a high temperature than the comparative examples.

Tables 1 to 4 summarize the residual magnetization Mr(T), coercivity Hc (kOe), and degree of orientation Mr/Ms of the samples with degrees of processing of 0%, 52%, 67% and 76% that were measured at each locations in a cross-section perpendicular to the compressional axis in the examples. In the tables, the value of M27 k(T) (magnetization at applied magnetic field of 27 kOe) and the maximum energy product BHmax (MGOe) are also shown.

TABLE 1

| | | | | | | |
|---|---|---|---|---|---|---|
| Unworked | | | | | | Equivalent |
| sintered | Hc | Mr | M27k | | BHmax | degree of |
| body | (kOe) | (T) | (T) | Mr/Ms | (MgOe) | processing |

| | | | | | | |
|---|---|---|---|---|---|---|
| Location | 20.29 | 0.759 | 1.002 | 0.506 | 12.5 | |
| 1 | 21.50 | 0.788 | 1.029 | 0.525 | 13.5 | 0.00 |
| 2 | 21.68 | 0.784 | 1.025 | 0.523 | 13.4 | 0.00 |
| 3 | 21.15 | 0.796 | 1.026 | 0.531 | 13.6 | 0.00 |
| 4 | 21.56 | 0.795 | 1.040 | 0.530 | 13.7 | 0.00 |
| 5 | 21.67 | 0.796 | 1.032 | 0.531 | 13.6 | 0.00 |
| 6 | 21.50 | 0.776 | 1.027 | 0.517 | 12.9 | 0.00 |
| 7 | 21.33 | 0.778 | 1.016 | 0.519 | 13.2 | 0.00 |
| 8 | 21.52 | 0.786 | 1.024 | 0.524 | 13.4 | 0.00 |
| 9 | 21.20 | 0.788 | 1.021 | 0.525 | 13.2 | 0.00 |

TABLE 2

| | | | | | | Equivalent |
|---|---|---|---|---|---|---|
| 52% | Hc | Mr | M27k | | BHmax | degree of |
| Location | (kOe) | (T) | (T) | Mr/Ms | (MgOe) | processing |
| 2 | 18.80 | 1.141 | 1.253 | 0.760 | 30.1 | 0.54 |
| 4 | 18.38 | 1.155 | 1.255 | 0.770 | 30.8 | 0.57 |
| 6 | 19.13 | 1.125 | 1.236 | 0.750 | 29.2 | 0.52 |
| 7 | 18.77 | 1.165 | 1.264 | 0.776 | 31.5 | 0.58 |
| 13 | 18.96 | 1.124 | 1.238 | 0.750 | 29.1 | 0.52 |

TABLE 3

| | | | | | | Equivalent |
|---|---|---|---|---|---|---|
| 67% | Hc | Mr | M27k | | BHmax | degree of |
| Location | (kOe) | (T) | (T) | Mr/Ms | (MgOe) | processing |
| 1 | 16.47 | 1.224 | 1.300 | 0.816 | 35.1 | 0.68 |
| 2 | 16.27 | 1.233 | 1.303 | 0.822 | 35.9 | 0.69 |
| 3 | 15.89 | 1.234 | 1.297 | 0.823 | 36.2 | 0.70 |
| 4 | 16.55 | 1.219 | 1.291 | 0.813 | 34.9 | 0.67 |
| 5 | 16.11 | 1.208 | 1.281 | 0.805 | 34.4 | 0.65 |
| 6 | 15.99 | 1.241 | 1.311 | 0.827 | 36.1 | 0.71 |
| 7 | 15.72 | 1.234 | 1.300 | 0.822 | 36.0 | 0.69 |
| 8 | 16.42 | 1.228 | 1.297 | 0.819 | 35.7 | 0.68 |
| 9 | 17.72 | 1.127 | 1.228 | 0.751 | 29.3 | 0.52 |

TABLE 4

| | | | | | | Equivalent |
|---|---|---|---|---|---|---|
| 76% | Hc | Mr | M27k | | BHmax | degree of |
| Location | (kOe) | (T) | (T) | Mr/Ms | (MgOe) | processing |
| 1 | 14.57 | 1.228 | 1.300 | 0.819 | 35.1 | 0.69 |
| 2 | 14.91 | 1.183 | 1.283 | 0.789 | 31.7 | 0.61 |
| 3 | 14.48 | 1.259 | 1.333 | 0.839 | 36.7 | 0.74 |
| 4 | 14.51 | 1.281 | 1.354 | 0.854 | 37.7 | 0.77 |
| 5 | 14.72 | 1.273 | 1.346 | 0.848 | 37.6 | 0.76 |
| 6 | 14.65 | 1.263 | 1.340 | 0.842 | 36.7 | 0.74 |
| 7 | 14.76 | 1.226 | 1.297 | 0.817 | 35.0 | 0.68 |
| 8 | 14.81 | 1.255 | 1.325 | 0.837 | 36.7 | 0.73 |
| 9 | 15.02 | 1.256 | 1.328 | 0.837 | 36.7 | 0.73 |

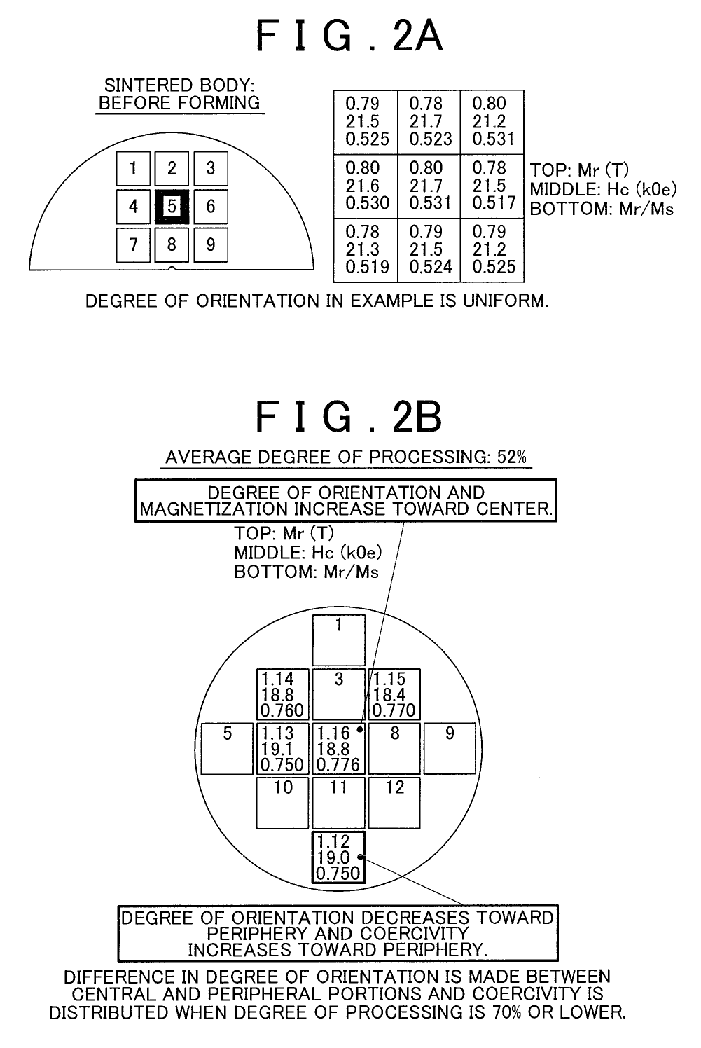

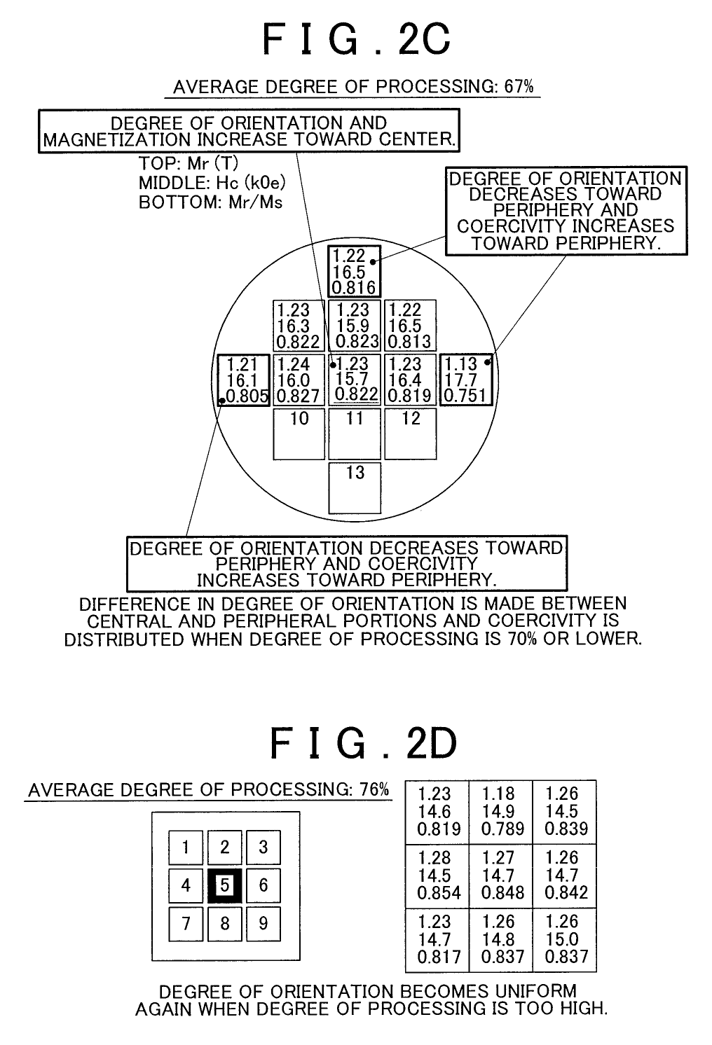

In FIG. 2A to 2D, the measurements are shown in Tables 1 to 4 are shown in the corresponding positions in a cross-section perpendicular to the compressional axis.

The degree of orientation is generally uniform across the entire surface for a degree of processing of 0% (without any processing after sintering), is high in the central portion and low in the peripheral portions for degrees of processing of 52% and 67%, and is generally uniform again across the entire surface for a degree of processing of 76%. This indicates that there is a suitable range of degree of processing to obtain such a distribution of degree of orientation.

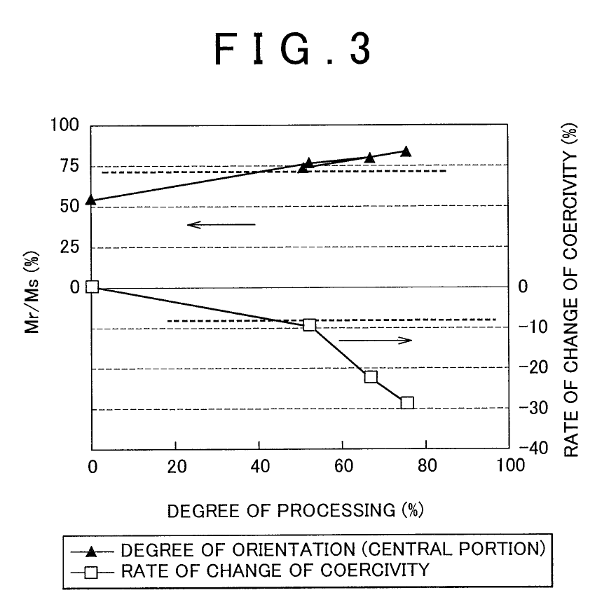

FIG. 3 shows the relation among the degree of processing, degree of orientation, and rate of change of coercivity in central portions of the samples.

Since the number of measured locations per sample is different for different degrees of processing, the locations of the central portion are different for different degrees of processing in Tables 1 to 4 and FIG. 2A to 2D. For example, degree of processing of 0% is shown at “No. 5”, 52% is shown at “No. 7”, 67% is shown at “No. 7” and 76% is shown at No. 5”.

As shown in FIG. 3, the relation between the degree of processing and degree of orientation Mr/Ms is almost linear and can be approximated by the following linear expression,

x=2.44×(y−53.8)

where x is degree of processing (%) and y is degree of orientation (Mr/Ms).

Because the degree of orientation needs to be 75% or higher for practical use, it is evident from FIG. 3 that a degree of processing of 40% or higher is required.

However, when the degree of processing is too high, the degree of orientation tends to become rather uniform as in the case of the degree of processing of 76% as shown in FIG. 2A to 2D. Therefore, the degree of processing may not exceed approximately 70%.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A method of producing a permanent magnet comprising:
forming a multiplicity of solidified ribbons that are composed of nanosized crystal grains by melting a magnet material and rapidly cooling the molten product;
binding the multiplicity of solidified ribbons together by compression molding and sintering to form a sintered body; and
performing plastic forming on the sintered body to provide the sintered body with a distribution of strain which increases from a peripheral portion to a central portion.

2. The method according to claim 1, wherein the solidified ribbons are formed in an inert atmosphere by melting a compound that has a chemical composition of Nd₁₅Fe₇₇B₇Ga₁ using an arc smelting furnace and cooling by pouring the molten product onto a circumferential surface of a cooling disk from a molten temperature of 1450° C.

3. The method according to claim 1, wherein the solidified ribbons are composed of powder particles which have grain size of 30 nm to 500 nm.

4. The method according to claim 1, wherein the sintering is carried out by rapidly heating from 500 to 700° C. at a rate of 20° C./sec and then rapidly cooling at an initial cooling rate of 10 to 50° C./sec.

5. The method according to claim 4, wherein the compression molding is carried out at a pressure of 100 MPa or higher.

6. The method according to claim 5, wherein the duration of the sintering and compression molding is within one minute.

7. The method according to claim 1, wherein the plastic forming is performed by means of uniaxial compression and the strain is distributed in a plane perpendicular to a compressional axis.

8. The method according to claim 7, wherein the plastic forming is carried out at a temperature of 600° C. to 700° C., a heating rate of 2° C./sec to 50° C./sec, and a compression pressure of 100 MPa.

9. The method according to claim 7, wherein the plastic forming is carried out with a degree of processing in the range of 40% to 70%, the degree of processing being defined as [(T0−T)/T0]×100, where T0 represents the height of workpiece before compression and T represents the height of workpiece after compression.

10. A permanent magnet comprising:
a central portion; and
a peripheral portion that is formed around the central portion,
wherein the central and the peripheral portions are formed of multiplicity of nanosized crystal grains that have been bound together by sintering, and
wherein the central and peripheral portions have a uniform chemical composition across the entire portions of the central and peripheral portions, and have a distribution of degree of orientation which increases from the peripheral portion to the central portion.

11. The permanent magnet according to claim 10, wherein the central and peripheral portions have a distribution of coercivity which decreases from the peripheral portion to the central portion and a distribution of magnetization which increases from the peripheral portion to the central portion.

12. The permanent magnet according to claim 10, wherein the degree of orientation is defined by the percentage of the ratio between residual magnetization Mr to saturation magnetization Ms, and the degree of orientation is 75% or higher at lowest in the peripheral portion.

13. The permanent magnet according to claim 10, wherein the degree of orientation represents a degree at which each of the crystal grains that form the permanent magnet is oriented in a specific direction.

14. The permanent magnet according to claim 10, wherein each of the crystal grains that form the permanent magnet has a crystal grain size of 30 nm to 500 nm.

15. A motor comprising a permanent magnet according to claim 10.
